(19) United States
(12) Patent Application Publication
(10) Pub. No.: US 2024/0119461 A1
(43) Pub. Date: Apr. 11, 2024

(54) SYSTEM AND METHOD FOR FACILITATING PROSPECT AND REFERENCE ENGAGEMENT THROUGH SMART MATCHING

(71) Applicant: Deeto Inc., Tenafly, NJ (US)

(72) Inventor: Golan RAZ, Tenafly, NJ (US)

(73) Assignee: Deeto Inc., Tenafly, NJ (US)

(21) Appl. No.: 18/484,152

(22) Filed: Oct. 10, 2023

Related U.S. Application Data
(60) Provisional application No. 63/378,914, filed on Oct. 10, 2022.

(51) Int. Cl. G06Q 30/015

(52) U.S. Cl. CPC G06Q 30/015

(57) ABSTRACT

A system and a method for facilitating an engagement through smart matching is provided. The method includes: determining a score for at least one reference based on a plurality of matching rules applied to at least one reference profile of the at least one reference and a prospect profile for a prospect, wherein the plurality of matching rules is modified by feedback data from an engagement between the at least one reference and the prospect; identifying, based on the determined score, a matching reference from the at least one reference for the prospect; and tracking the engagement between the matching reference and the prospect, wherein the engagement includes a plurality of stages, wherein tracking further comprises collecting the feedback data from each stage of the plurality of stages in the engagement.

### CROSS-REFERENCE TO RELATED APPLICATIONS

This application claims the benefit of U.S. Provisional Application No. 63/378,914 filed on Oct. 10, 2022, the contents of which are hereby incorporated by reference.

### TECHNICAL FIELD

The present disclosure generally relates to data processing and more particularly to a system, method, and platform to facilitate and increase user engagement.

### BACKGROUND

The abundance and accessibility of various information have much impact on decision-making in modern times. Such impact is particularly notable in areas of sales and marketing where information provided by existing customers, for example as reviews, are key factors for selling of products and/or closing of deals. To this end, effective utilization of existing customers as advocates for the business is highly desired. A large part of utilizing existing customers relates to customer data management and processing in order to provide applicable information to the potential customer. Thus, efficient data processing, particularly when a large amount of customer data is collected, is critical.

Current approaches in promotion and sales are often limited to established solutions and protocols without customization to meet potential customer needs, character, and the like. For example, potential customers are provided with pre-written reviews of existing customers for unspecified personnel. Not only can such reviews be unrelatable for certain potential customers, but they can also quickly become outdated to reflect inaccurate information.

In some cases, existing customers are introduced as references for one-on-one interactions with the potential customer to answer specific questions and concerns. Although such interactions allow some degree of personalized experience, even then, the resources are limited to the knowledge of the selected existing customer who may have vastly different background and interests to that of the potential customer; and thus, failing to provide necessary information. The existing customers are often selected from a short list of options, either due to established protocols or from unawareness of alternatives, with few factors considered for matching. And customer data for all customers can remain largely unchanged unless manually changed, which results in an inaccurate reflection of the customer's needs and opinions. To this end, accurate matching of potential and existing customers to successfully close sales remains a challenge.

In addition to the stagnant customer data, a large amount of data remains undiscovered and unexploited. Current techniques of customer management are often focused on collecting individual customer data in regard to the business without the ability to oversee all parts of the customer interactions. Particularly, interactions between customers occur external to current customer management techniques, and thus, valuable data available in each interaction and process are lost. These undiscovered data, when analyzed, can provide insights into each customer, customer interactions, as well as sales in general that can be advantageously utilized. Thus, techniques to recover and process these data to be implemented for truly personalized experiences for customers are desired.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for facilitating an engagement through smart matching. The method comprises: determining a score for at least one reference based on a plurality of matching rules applied to at least one reference profile of the at least one reference and a prospect profile for a prospect, wherein the plurality of matching rules is modified by feedback data from an engagement between the at least one reference and the prospect; identifying, based on the determined score, a matching reference from the at least one reference for the prospect; and tracking the engagement between the matching reference and the prospect, wherein the engagement includes a plurality of stages, wherein tracking further comprises collecting the feedback data from each stage of the plurality of stages in the engagement.

Certain embodiments disclosed herein also include a non-transitory computer readable medium having stored thereon causing a processing circuitry to execute a process, the process comprising: determining a score for at least one reference based on a plurality of matching rules applied to at least one reference profile of the at least one reference and a prospect profile for a prospect, wherein the plurality of matching rules is modified by feedback data from an engagement between the at least one reference and the prospect; identifying, based on the determined score, a matching reference from the at least one reference for the prospect; and tracking the engagement between the matching reference and the prospect, wherein the engagement includes a plurality of stages, wherein tracking further comprises collecting the feedback data from each stage of the plurality of stages in the engagement.

Certain embodiments disclosed herein also include a system for facilitating an engagement through smart matching. The system comprises: a processing circuitry; and a memory, the memory containing instructions that, when executed by the processing circuitry, configure the system to: determine a score for at least one reference based on a plurality of matching rules applied to at least one reference profile of the at least one reference and a prospect profile for a prospect, wherein the plurality of matching rules is modified by feedback data from an engagement between the at least one reference and the prospect; identify, based on the determined score, a matching reference from the at least one reference for the prospect; and track the engagement between the matching reference and the prospect, wherein the engagement includes a plurality of stages, wherein tracking further comprises collecting the feedback data from each stage of the plurality of stages in the engagement.

Certain embodiments disclosed herein include the method, non-transitory computer readable medium, or system noted above, further including or being configured to perform the following steps: generating a notification that includes the matching reference and an invitation for the engagement; and causing display of the notification via a user device.

Certain embodiments disclosed herein include the method, non-transitory computer readable medium, or system noted above, wherein the notification includes at least one of: the prospect, the matching reference, a proposed engagement method, and a proposed engagement schedule.

Certain embodiments disclosed herein include the method, non-transitory computer readable medium, or system noted above, further including or being configured to perform the following steps: generating the at least one reference profile for the at least one reference based on reference data received from at least one of: a customer relationship management (CRM) system, a vendor device, a user device, and web sources; and creating the prospect profile for a potential customer.

Certain embodiments disclosed herein include the method, non-transitory computer readable medium, or system noted above, wherein the feedback data includes engagement data and associated metadata for each stage of the plurality of stages in the engagement.

Certain embodiments disclosed herein include the method, non-transitory computer readable medium, or system noted above, wherein the metadata indicates performance of the engagement data that are collected at the each stage of the plurality of stages in the engagement.

Certain embodiments disclosed herein include the method, non-transitory computer readable medium, or system noted above, further including or being configured to perform the following steps: extracting content data from the engagement data; and updating a reference profile of the matching reference based on the extracted content data and the associated metadata.

Certain embodiments disclosed herein include the method, non-transitory computer readable medium, or system noted above, wherein a matching rule of the plurality of matching rule includes a disqualifying feature for eliminating portions of the at least one reference profile prior to determining the score.

Certain embodiments disclosed herein include the method, non-transitory computer readable medium, or system noted above, wherein the at least one reference is selected from existing customers in a CRM system based on one or more selection rules.

Certain embodiments disclosed herein include the method, non-transitory computer readable medium, or system noted above, further including or being configured to perform the following steps: aggregating the feedback data from a plurality of engagements, wherein the plurality of engagements are between a plurality of the at least one references and a plurality of the prospects, wherein the plurality of engagements are associated with a vendor; extracting content data from the aggregated feedback data for the vendor, identifying at least one topic based on insight scores determined from the extracted content data; and generating a report including the identified at least one topic for display at a vendor device of the vendor.

Certain embodiments disclosed herein include the method, non-transitory computer readable medium, or system noted above, wherein content data to extract is predetermined by the vendor.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram utilized to describe the various embodiments.

FIG. 2 is a flowchart illustrating a method for identifying a reference using smart matching according to an embodiment.

FIG. 3 is a flowchart illustrating a method for dynamically generating a reference profile for optimized matching according to an embodiment.

FIG. 4 is a flowchart illustrating a method for determining a subset of customers as references according to an embodiment.

FIG. 5 is an example image of a graphical user interface showing a question-and-answer session to collect reference data according to an example embodiment.

FIG. 6 is a schematic diagram of a server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments provide a system and a method for facilitating active engagement between potential customers and existing customers through a customer match platform. A smart matching technique is provided for personalized matching of existing customers (i.e., references) to a potential customer (i.e., a prospect) to promote effective engagement and communications between these customers within the platform. In addition, the disclosed techniques provide a system and a method to monitor and analyze such prospect-reference engagements to dynamically improve matching as well as actual communications that take place. The customer match platform, disclosed herein, establishes a start-to-finish tracking and analysis system that facilitates the engagement and continuously improves accuracy and efficiency of prospect-reference matching.

The disclosed embodiments provide an objective rules-based process that enables thorough analysis of data to provide consistent and reproducible matching outputs. While a vendor entity, such as a sales representative, may select a matching reference through manual comparison of certain features, selection of important features may be highly subjective. The vendor may select the feature to compare based on their “feeling” of importance rather than rules or the customer information, which results in inconsistent outputs. In comparison, the techniques provided herein apply a plurality of matching rules that are defined by, for example, weights, scores, ranking, and the like of certain parameters, to objectively analyze customer data available of the prospect and the references to determine a matching reference for a specific prospect. In an embodiment, complete customer data are deployed for rules-based analysis for improved accuracy and reliability in determining the matching reference.

Particularly, the plurality of matching rules may be continuously modified through the feedback data gathered through smart matching and tracking of prospect-reference engagements. The feedback data may include, for example, but is not limited to engagement data, metadata, customer survey, and the like, and may be utilized to determine content data, aggregated performance data, and the like, for the reference and/or the vendor, and the like, and any combination thereof. The modification of the plurality of matching rules through feedback data enables automated convergence of matching rules to more accurate and vendor-specific criteria that may increase, for example, and not limited to, engagement performance. It should be noted that manual interventions may not only slow down the process of optimization, but also include undesired biases of a personnel performing the manual modification.

In addition, manual selection of matching references is not only time consuming but is limited to few references to cause exhaustion of these customers being repeatedly requested to be references. Unlike manual determination, by deploying the customer match platform, a wide range of possible references are accurately selected from existing customers to provide improved prospect-reference experiences for both the prospect and the references.

The disclosed embodiments provide techniques for filtering out existing customers that are unsuitable for matching to the prospects in order to improve data processing efficiencies. A subset of customers is selected as references based on analysis of existing customers, thereby determining top customers while reducing the number of references and associated data for matching. Moreover, at least one disqualifying feature (or category) is utilized to further eliminate unfitting references from the subset of customers that are selected as references prior to further analysis of each reference data. In an embodiment, the disqualifying feature include, for example, response rate, interest, personality trait, and the like, that are determined from, for example, but not limited to, text, audio, video, image, and the like, analyses of prospect-reference conversations (e.g., text exchanges, calls, and more) that occur within the customer match platform. In an embodiment, the disqualifying feature may be utilized as one of the plurality of matching rules. In this regard, the disclosed embodiments accurately determine matching references while reducing processing power and time, thereby conserving computing resources for determining matches and facilitating active engagements between customers. It should be noted that the efficient data processing of customer data allows near real-time or real-time matching and initiation of prospect-reference engagements to provide immediate personalized experiences for multiple customers concurrently.

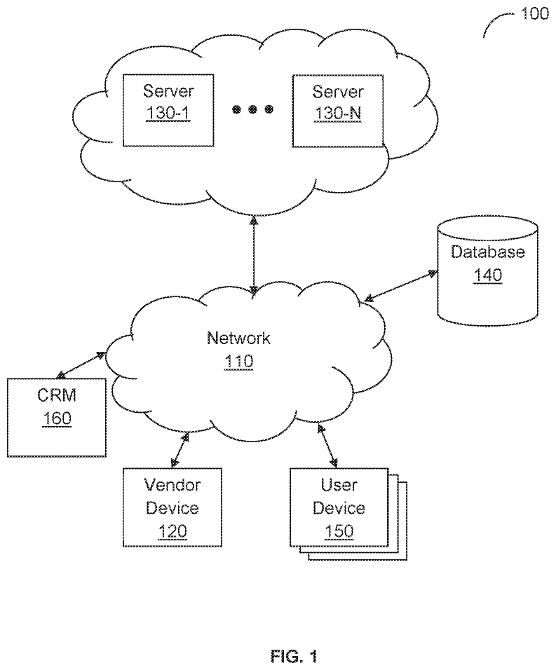

FIG. 1 shows an example network diagram 100 utilized to describe the various disclosed embodiments. In the example network diagram 100, a vendor device 120, a plurality of servers 130-1 through 130-N (hereinafter referred to individually as a server 130 and collectively as servers 130, merely for simplicity purposes, wherein N is an integer equal to or greater than 1), a database 140, a user device 150, and a customer relationship management (CRM) system 160 are communicatively connected via a network 110. The network 110 may be, but is not limited to, a wireless, cellular or wired network, a local area network (LAN), a wide area network (WAN), a metro area network (MAN), the Internet, the world wide web (WWW), similar networks, and any combination thereof.

The vendor device 120 and a user device 150 may each be, but is not limited to, a personal computer, a laptop, a tablet computer, a smartphone, a wearable computing device, or any other device capable of receiving, processing, and displaying notifications, reports, and the like. The vendor device 120 is associated with a vendor entity such as, but not limited to, a sales representative that may be presented with and/or interact with a customer match platform through a graphical user interface (GUI) presented on the vendor device 120. The customer match platform is configured in the server 130 to manage and facilitate prospect-reference engagements and related processes.

In an embodiment, the vendor device 120 is configured to display progresses and various stages of a prospect-reference engagement through, for example, but not limited to, notifications, progression timelines, lists of references, lists of prospects, and more, and any combination thereof. The vendor device 120 is further configured to receive inputs from vendor entities to, for example, modify customer information, select a reference, and more.

The user device 150 is associated with a customer of the vendor such as a potential customer (i.e., a prospect), a current customer, and the like. The current customer includes a subset of customers that are selected as references of the vendor to engage in conversations, or any communication, with the prospects. The user device 150 is configured to receive and display notifications for engagement in forms of, for example without limitation, emails, text messages, telephone calls, pop-ups, and the like, and any combination thereof. In an embodiment, the reference may receive a notification through the GUI of the customer match platform via its user device 150.

In addition, the user device 150 is utilized by each of the references and the prospects to participate in the conversation engagement with the matched counterpart through, for example, text, voice, video, and the like, over the network 110. It should be noted that a user device 150 is distinctly associated with a customer and may include input/output (I/O) devices such as, but not limited to, a microphone, camera, and the like, in order to communicate with and record such communications.

As an example, a first user device associated with a prospect and a second user device associated with a reference each receive an invitation notification via an email and a message through a GUI, respectively. Once the invitation is accepted and a meeting between the prospect and the reference is confirmed, the prospect using the first user device and the reference using the second user device may communicate over a video conference call using their respective user devices. In the same example, the vendor device may track a progress of engagement between the prospect and references through the GUI and access information about the participants, notifications sent out, conversation method selected, stage of engagement, and the like. In an embodiment, the communication during the prospect-reference engagement is a live interaction whether it is through text, video, audio, images, or the like. As an example, and without limitations, the engagement between the prospect and the reference includes email, video call, phone call, image, white paper, note, audio recording, exchange of chat messages, and the like, and any combination thereof. The prospect-reference engagement may be synchronous or asynchronous communications.

The customer relationship management (CRM) system 160 is a device, component, system, or the like, configured to store and manage customer information. The CRM 160 includes customer data with respect to the vendor including, for example, but not limited to, contact information, sales history, previous contact with vendor, and the like, and any combination thereof. In an embodiment, customer data of the CRM 160 is sent to the server 130 over the network 110. The customer data from the CRM 160 may include, for example, but not limited to, existing customers, current customers, potential customers (or prospect), and the like, and any combination thereof.

The database 140 may be part of the server 130 or may be separate and communicatively connected directly or over the network 110. The database 140 is configured to store various customer information such as, but not limited to, prospect profiles, reference profiles, engagement data, feedback data, and the like.

The server 130 is configured to receive and collect customer data to generate customer (or user) profiles of potential and reference customers. Each of the generated customer profiles may be stored within the server 130 and/or the database 140. A prospect profile is generated for a potential customer (i.e., prospect) who is interested in vendor products and/or services. Data for the prospect profile may be received as input through a vendor device 120 and/or a user device 150 including basic user data such as, but not limited to, name, company, industry, size of company, role or position in company, and the like, which may be customized. In some configurations, to generate prospect profiles, web sources (such as social media) may be queried.

In an embodiment, the fields of customer (or user) data to be collected may be customized through a vendor device 120. A reference profile is generated for a current (or existing) customer selected to be a reference for the vendor. In addition to the basic user data that are received as input from the vendor device 120 and/or the user device 150, other reference-related data may be collected.

In some implementations, the user data of a reference may also include, for example, but not limited to, inclined activity, user testimonials, and the like, that are input via the user device by, for example and without limitation, text, audio, video, images, and the like, and any combination thereof. The user data may be utilized to generate a customer voice including various user content in association with the vendor. In some example embodiments, such user data may be collected upon identifying the user as the reference from the current customers.

The server 130 is further configured to determine a matching reference for the prospect. Upon receiving prospect information, the server 130 is configured to perform an objective rules-based matching of the generated prospect profile to one or more reference profiles. The server 130 determines a score for each reference profile with respect to the given prospect profile based on a plurality of matching rules. The plurality of matching rules may include specific guidelines indicating how to determine the matching reference and are defined by weights, scores, rankings, and the like of parameters included in the reference profile and/or the prospect profile. In an embodiment, the server 130 is configured to determine scores for the multiple reference profiles to identify the matching reference, for example, with the highest score. In an example embodiment, one or more matching references may be determined based on a score above a predetermined threshold value. It should be noted that the objective rules-based matching of data included in the reference profile enables accurate and efficient matching between the prospect and the reference, which in return improves fulfillment of prospect-reference engagements.

In a further embodiment, the server 130 is configured to generate a notification to the prospect and the reference and cause a display via respective user devices 150 for live engagement. The notification may include, for example, but is not limited to, an invitation to a meeting, a set meeting time, a schedule for the engagement, and the like. It should be noted that matching of references for the prospect may be performed in real time to enable immediate engagement (or at least an initiation of engagement) between the matched prospect and reference upon receiving the prospect data. It should be further noted that the server 130 is configured to monitor different stages of the prospect-reference engagement to collect and analyze data within the generated customer match platform.

In some implementations, the notification may include different portions of the reference profile such as, but not limited to, basic information, preferred engagement method, one or more content of the customer voice, and the like, that are collected and generated during the onboarding process of the reference. In an embodiment, the reference profile may be stored in a database (e.g., the database 140, FIG. 1) and may be retrieved for smart matching and generation of the notification. The smart matching process described herein enables accurate determination of the matching reference as well as content types of the matching references that are relevant to the prospect.

It should be noted that the present disclosure is described with respect to a single vendor for simplicity and illustrative purposes and does not limit the scope of the various disclosed embodiments described herein. The server 130 is configured to simultaneously serve one or more vendors using customized policies for each vendor. The customized policy for each vendor includes a plurality of matching rules that guides determining a matching reference for a prospect. The plurality of matching rules is defined by, for example, weights, rankings, and the like, and may be further adapted and customized by applying at least the feedback data from the prospect-reference engagement such as, but not limited to, win rate, conversion rate, and the like, to accurately and consistently determine matching references for prospects of the associated vendor.

In some embodiments, the server 130 may be configured with an artificial intelligence (AI) engine (not shown) that may apply at least one algorithm, such as a machine learning algorithm, on data available in the prospect profile and the reference profile for the personalized matching.

The servers 130 are deployed in a cloud computing platform such as, but not limited to, a public cloud, a private cloud, or a hybrid cloud. Example cloud computing platforms include Amazon® Web Service (AWS), Cisco® Metacloud, Microsoft® Azure®, Google® Cloud Platform, HP® Cloud, and the like. In an embodiment, when installed in the cloud, the server 130 may operate as a Software as a service (SaaS).

In some embodiments, the server 130 is integrated in the CRM 160 deployed in a cloud computing platform.

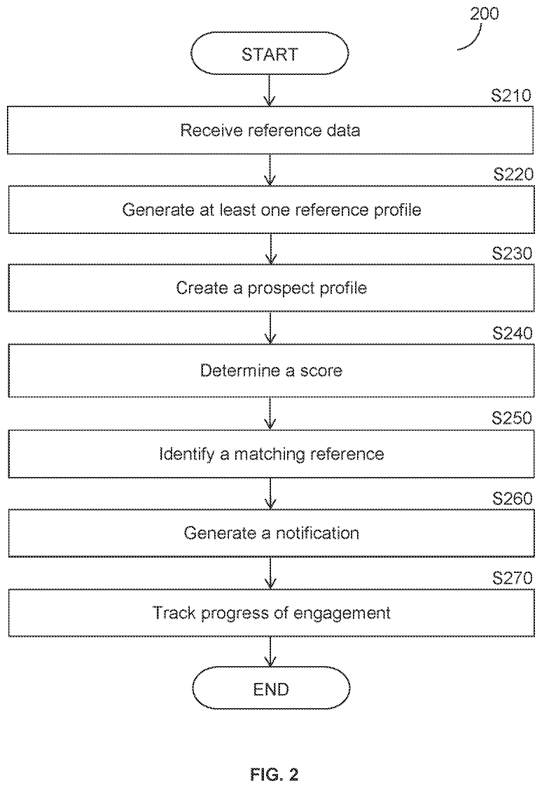

FIG. 2 is an example flowchart 200 illustrating a method for identifying a reference using smart matching according to an embodiment. The method described herein may be executed by the servers 130, FIG. 1. It should be noted that the method is described for a single prospect, but such method may be simultaneously performed for multiple prospects and references at the servers 130, FIG. 1.

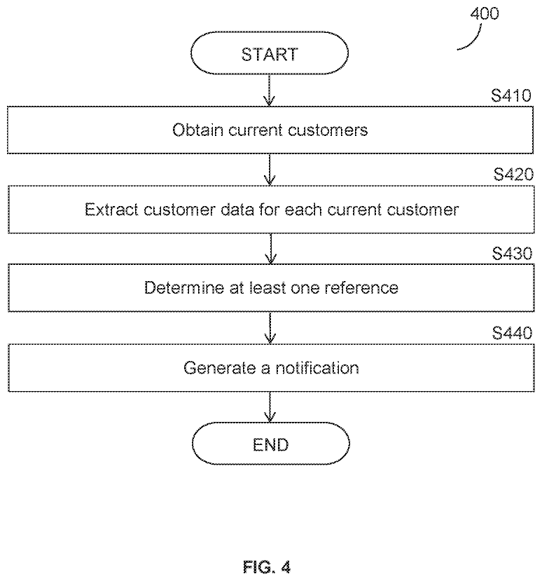

At S210, reference data is received for a reference customer (i.e., the reference). In an embodiment, a reference is selected from current (or existing) customers of a vendor as discussed herein below in FIG. 4. A plurality of selection rules is applied to the customer data in order to determine strong references that may well represent the vendor and/or vendor products to convince potential customers. In another embodiment, the references may be predetermined.

The reference data includes, but is not limited to, basic user data, metadata, vendor data, external user data, and the like. In an embodiment, the basic user data may include, without limitation, name, company, industry, size of company, role or position in company, and the like, and any combination thereof, which may be obtained through input via a vendor device and/or a reference associated user device. In an embodiment, reference data may be obtained from multiple sources over the network. The metadata indicates performance and history of the reference within the customer match platform to include, for example, conversion rate from engagement to closing of the deal, time taken to close the deal, rating received from engaged prospect, selection history for engagements, stage of the deal, number of deals closed, and other relevant information that may be retrieved from a CRM, and more. In an example embodiment, at least one method of activity and/or engagement that the reference is willing to participate in may be received as a reference input. The at least one method of activity includes, for example, but not limited to, text (e.g., email communication, article, etc.), voice, video, webinar, panel, onsite, one-on-one, and the like, and any combination thereof.

In an embodiment, the vendor data is received from the vendor's customer relationship management (CRM), customer success system, and the like, that indicate, for example, vendor product usage (e.g., product tier, time of usage, etc.), number of tickets, number of case studies, and the like, and more. In addition, external user data may be collected from various external sources such as, but not limited to, social media, to extract user information, for example, education, workplace, certifications, and the like.

At S220, a reference profile is generated for the reference from the plurality of reference data received. In an embodiment, a reference profile is individually generated for each of the references in a selected group of references. In an embodiment, the reference profiles may be organized into categories and subcategories based on, for example but not limited to, industry, product usage, ratings, deal size, seniority, and the like, and more. It should be noted that the categorization of large amounts of reference data allows faster, improved processing efficiencies.

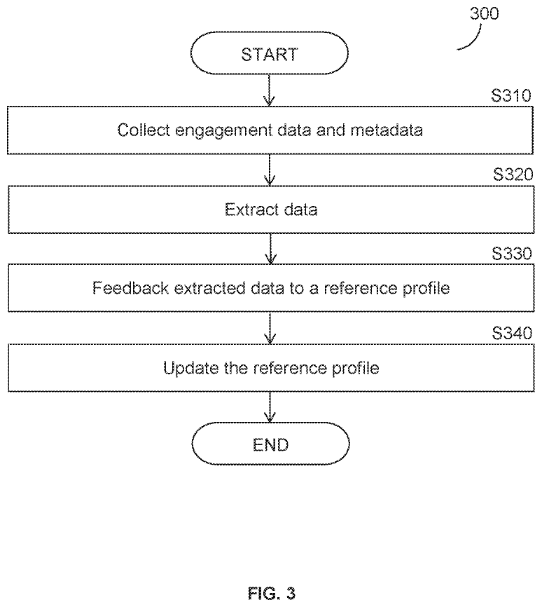

It should be further noted that the reference profile does not remain identical to the initial reference profile created upon entry into the customer match platform. Instead, the reference profiles are dynamically updated with collection of new reference-related data. The method of dynamically modifying the reference profile is discussed in further detail in FIG. 3. In an embodiment, the operations of S210 to S220 to collect and generate reference profiles may be performed at any time and/or in parallel and are operationally distinct to the following steps. In an embodiment, the generated reference profiles are stored in a memory (not shown) and/or a database (e.g., the database 140, FIG. 1) and are obtained as needed, for example, to determine matching, to update profile, and more.

In some implementations, user impressions or testimonials with respect to the vendor (e.g., service, product, etc.) may be received as part of the user data that is input via the reference associated user device. The user impression may be collected through, for example, direct testimonials, answers to predetermined questionnaires, and the like, in various forms such as, but not limited to, text, audio, video, images, and the like, and any combination thereof. One or more sets of questionnaires may be predetermined by the vendor and different sets may be presented to different references based on a questionnaire rule which may be predetermined by the vendor.

In one embodiment, a customer voice including various content, for example, but not limited to, a quote, a review, a question and answer, a video, a user story (e.g., summary), and the like, and any combination thereof, may be created and stored in the database (e.g., the database 140, FIG. 1), for example, as part of the reference profile. The contents of the customer voice describe the reference's impressions, thoughts, testimonials, and the like of the vendor, as well as the impact of the vendor for each of the references from their personal experiences. In some implementations, at least one algorithm may be applied to the reference data to create the customer voice. It should be noted that the customer voice including the various content may be generated near real-time. It should be further noted that the customer voice provides additional data of the reference that may be utilized in matching to the prospect, thereby, in some cases, reducing the number of references to process.

At S230, a prospect profile is created for a potential customer (i.e., the prospect). The prospect profile is generated from prospect data including, for example, but not limited to, name, role, company, industry, product of interest, and the like. The prospect data is obtained from a vendor device (e.g., the vendor device 120, FIG. 1) or a user device (e.g., the user device 150, FIG. 1) associated with the potential customer. In some embodiments, the prospect profile may include data from the CRM (e.g., the CRM 160, FIG. 1) and/or web sources.

At S240, a score between the at least one reference profile and the prospect profile is determined. A plurality of matching rules is applied to the reference data and the prospect data of the generated reference profile and the prospect profile, respectively to objectively determine the match. In an embodiment, the plurality of matching rules is utilized to define for example and without limitations, weights, scores, ranking, and the like of, parameters such as, but not limited to, common features, performances, personal attributes, and the like, and more. In an example embodiment, the performance is determined based on data such as vendor data obtained through a CRM (e.g., close rate, reviews, tickets, product usage, and more) and the personal attributes may be determined based on metadata and feedback data collected in the customer match platform (e.g., availability, response rate, response time, cancellation rate, ratings, interests, conversion rate, closing rate, and more) during various stages of the prospect-reference engagement. In an embodiment, the plurality of matching rules may be objectively modified based on feedback to improve accuracy and to be tailored for specific vendors. As an example, the weight of a certain reference profile trait (e.g., personal attribute) or a method of engagement may be changed to be greater based on high performance rates identified from the feedback data.

In a further embodiment, the plurality of matching rules includes disqualifying features to filter out reference profiles from matching against the prospect profile when disqualifying features do not match. For example, industry may be a disqualifying feature and a prospect profile includes “retail” for the industry field. In such a case, all references with values other than “retail” for the industry field may receive a score of “0” and be eliminated from matching. In another example, interest in “parenthood” may be a disqualifying feature for a prospect who is a student in the fashion industry seeking a vendor for their new fashion brand. In an embodiment, the disqualifying feature may be data fields of the profile including, but not limited to, industry, cancellation rate, interests, preferred engagement method, and the like. In one embodiment, scores such as, but not limited to, an aggregated score for the reference, one or more scores for each feature and/or category of data, and the like, may be accessed by a vendor via a GUI on a vendor device (e.g., the vendor device 120, FIG. 1). In an embodiment, the determined scores are stored in a memory and/or a database (e.g., the database 140, FIG. 1).

In some embodiments, at least one algorithm, such as a machine learning algorithm, is applied to the prospect profile, reference profile, and feedback data to create and modify the plurality of matching rules for improved matching with high accuracy and consistency. In an embodiment, the feedback data includes data collected during different stages of the prospect-reference engagement process including, but not limited to, conversion rate, closing rate, response time, engagement method, and the like, and more.

At S250, a matching reference is identified based on the determined score. In an embodiment, the reference profile with the highest score with respect to the prospect profile is identified as the matching reference. In an embodiment, one or more matching references may be identified for the prospect profile based on the determined score, for example, but not limited to, the score above a predetermined threshold value. In a further embodiment, the one or more matching references may be provided to a vendor entity via a GUI on a vendor device (e.g., the vendor device 120, FIG. 1).

At S260, a notification is generated of the matching reference. The notification may be caused to be displayed at user devices of the prospect and the matching reference. In an embodiment, the notification may be an invitation for a prospect-reference engagement (e.g., a meeting or text exchange) with the matched counterpart including information, for example, engagement method (e.g., one or more suggested method), time, and options for the meeting. The notification may be generated and presented in the form of, for example, but not limited to, an email, a text message, a pop-up, and the like. In an embodiment, at least one algorithm (i.e., a smart scheduling algorithm) may be applied to prospect and reference schedule data to determine at least one time and/or method for the prospect-reference engagement which includes, for example, without limitation, a text exchange, video conference call, a telephone call, and the like, and more.

In some implementations, the notification generated for the prospect may include portions of the customer voice of the matching reference. One or more of the various contents in the customer voice such as, but not limited to, a quote, a review, a question and answer, a video, a user story (e.g., summary), and the like, may be included in the notification for display at the user device of the prospect. In an example embodiment, the portions of the customer voice (i.e., content type) may be selected by smart matching between the matching reference and the prospect based on, for example, but not limited to, content type, topics discussed in the content, prospect profile, and the like, and more. Here, the plurality of matching rules may be applied to each portion of the customer voice. In a further example embodiment, the vendor entity may select the content type to include in the notification from the customer voice or from the portions of the customer voice determined through the smart matching. As an example, the notification generated for the prospect includes prospect-reference engagement information and information of the matching reference: basic information, a question and answer, a user story, and a stage of engagement. It should be appreciated that selecting and displaying portions of the customer voice of the matching reference allows further personalized matching with improved accuracy for faster prospect-reference engagement fulfillment.

At S270, a progress of the prospect-reference engagement is tracked. Each stage of the prospect-reference engagement is tracked from the match, initial contact, scheduling of the meeting, and the like, and more, until the meeting is completed, and feedback is received. In an embodiment, the feedback includes a customer survey from the prospect and/or the reference. The customer survey collected after the meeting indicates match and conversation satisfactions whether the prospect received answers to their inquiries. In a further embodiment, the feedback includes engagement data obtained of the specific prospect-reference engagement and the extracted content data therefrom. The feedback data includes engagement data, metadata, customer survey, and the like, and any combination thereof. The feedback data may be analyzed to extract contents about the engagement as well as the participants involved in the engagement. In an example embodiment, the content data includes discussions during the engagement, for example, topics, sentiments, quotes, specific terms mentioned, and the like, and more. It should be appreciated that tracking of the prospect-reference engagement process is enabled by the customer match platform of the server (e.g., the server 130, FIG. 1), which manages all processes of the engagement from collecting customers through actual engagements and feedback.

In an embodiment, the tracked progress in the customer match platform may be accessed through the GUI on the vendor device (e.g., the vendor device 120, FIG. 1). The vendor entity, such as a sales representative, may monitor progression and intervene if desired. In a further embodiment, a notification is generated at different stages of prospect-reference engagement. Moreover, a notification may be generated upon detecting problems in the engagement progress, for example, but is not limited to, stalling at a stage beyond a predetermined threshold time limit, a specific request from a prospect or a reference, and the like, and more. As an example, an alert is generated and caused to be displayed at a vendor device when an invitation to engage is not accepted for more than 3 days. In another example, an alert may be generated upon detecting multiple rescheduling attempts for the meeting above a predetermined number of times. In yet another example, an alert may be generated upon detecting an absence of the reference at the scheduled meeting time. In an embodiment, the customer match platform may be automated to respond to notifications without vendor entity involvement.

In an embodiment, progress data is collected during tracking of the prospect-reference engagement process and used as feedback data for the reference profile and/or the prospect profile. Such progress data may include, for example, response time to invitation, time taken to schedule a meeting, meeting type, and the like, and more. The progress data may be part of the engagement data that are collected at various stages of the prospect-reference engagement process.

As an example, a reference profile is generated for a new reference, that is new to the customer match platform. The initial reference profile may not include metadata indicating performance within the customer match platform such as the number of engagements, rating received from an engaged prospect and the like. However, upon matching and engagements with prospects through the platform, new reference-related data are retrieved such as rating received for engagement, conversion rate, and the like. The new reference-related data are not limited to metadata extracted within the platform, but also include any changes or updates that may be collected of basic user data, external data, and the like, and more. Some example changes may include a reference manually changing basic information on the platform, updating their social media account, updates in the CRM, and the like, and more.

In some implementations, the smart matching may be performed for a group of prospects and a category of prospects for the vendor. As an example, a group of prospects or a category of prospects is a demographic group of website visitors, a demographic group of social page followers, geographic group, and the like, and any combination thereof. In yet another implementation, the prospect may be a specific visitor of a webpage that answers a few introductory questions indicating their interest and/or identity. In such scenarios, portions of the reference profile may be provided to the prospect by exploiting the methods described herein. It should be noted that such selected portions (or content) may be pushed out into external platforms such as social pages, websites, and the like, and any combination thereof.

FIG. 3 is an example flowchart 300 illustrating a method for dynamically generating a reference profile for optimized matching according to an embodiment. The method described herein may be performed in the server 130, FIG. 1. It should be noted that the method described herein may be performed in real-time or near real-time of the occurrence of the prospect-reference engagement meeting.

At S310, engagement data and associated metadata are collected. The engagement data is a recording of the prospect-reference engagement that occurred through the customer match platform and is in the form of, for example but not limited to, voice, text, video, and the like. The engagement between the prospect and the reference may be in one or more of the various formats, for example, but not limited to, emails, exchanged chat messages, images, audio recordings, articles, and the like, and more. In an embodiment, the associated metadata includes information about the conversation such as, but not limited to, participants, method of engagement, duration, and the like. In an embodiment, the engagement data may be stored in a database (e.g., the database 140, FIG. 1) upon occurrence of the prospect-reference engagement. In an embodiment, the engagement data may be processed and labeled.

At S320, content data are extracted from the engagement data. In an embodiment, at least one algorithm such as a natural language processing (NLP) algorithm is applied to the engagement data to extract content data such as, but not limited to, topics, sentiments, personality traits, and the like.

At S330, the extracted data and the metadata are feedback as more reference data for the specific reference that participated in the prospect-reference engagement.

At S340, the respective reference profile is updated based on the obtained feedback data. The feedback data is utilized to add fields and/or change values in the previously generated reference profile. As an example, the extracted data includes topics on after-hour support and product usage in e-commerce. Such topics are added to the reference profile as topics of discussion, which may be added as areas of specialty or interest for which the reference may discuss and are utilized for smart matching. As another example, the extracted data includes topics of motherhood in relation to the vendor's product (e.g., automobile). Such topics may be added to the reference profile to be applied to smart matching this reference to future prospects with similar needs or profiles.

It should be noted that such updating of the reference profile provides additional information about the reference that is not obtained through the various sources used for collecting reference data. It should be further noted that the real-time implementation of the feedback data allows improved and optimized matching between the prospect and the reference for engagement. In an embodiment, the additional data collected and added to the reference profile may be utilized to determine personal attributes when determining scores. In a further embodiment, the new data added to the reference profile is used as a disqualifying feature for determining a score and a matching reference in order to increase accuracy and processing speed. It should be appreciated that the obtained feedback enables efficient processing of data without draining computing resources.

In an embodiment, an analysis of plurality of prospect-reference engagements may be performed to generate insight reports. Here, multiple prospect-reference engagements are aggregated regardless of participants and at least one algorithm, such as an NLP algorithm, or machine learning algorithm, is applied to understand the contents discussed during these meetings. In some example implementations, the amount and/or types of prospect-reference engagements to aggregate may be predefined and may be modified based on the vendor's needs. In an example embodiment, the insight report may include various topics, positive and/or negative sentiments, engagement metadata, and the like as well as corresponding insight scores. Some example sections in the report may include after-hour support, sales experience, user friendliness, response time, resolution time, and more.

In a further embodiment, topics for extraction may be customized and predetermined based on the vendor's needs. For example, topics and/or terms such as competitor names, product names, customer service via chat may be selected to be discovered. In an embodiment, the extracted data are compared to, for example but not limited to, industry benchmarks, competitor scores, and the like to highlight certain sections that the vendor may improve upon or give more attention to. It should be appreciated that such extraction and analysis of data allows generation of insights that may otherwise be unrecovered and lost. It should be further appreciated that such analysis of multiple engagements are enabled by the customer match platform that encompasses all stages of the engagements.

In some embodiments, a compensation such as, but not limited to, a gift card, a donation, vendor promotion, a discount, and the like, is provided to a reference upon completion of the prospect-reference engagement. The value of compensation may be determined by a vendor entity and/or the customer match platform based on the analysis of engagement data, progression data, feedback, and the like, and any combination thereof. It should be appreciated that such a compensation mechanism is enabled by the data collected through the customer match platform.

FIG. 4 is an example flowchart 400 illustrating a method for determining references from current customers according to an embodiment. The method described herein may be performed in the server 130, FIG. 1. In an embodiment, a subset of customers may be identified as references of the customer match platform. The references are determined to identify top customers that may well-represent as advocates of the vendors through prospect-reference engagement.

At S410, current customers of a vendor are obtained. In an embodiment, the current customers may be obtained from, for example, a customer relationship management (CRM) system, a customer success system, and the like.

At S420, customer data for each current customer is extracted. The customer data includes, for example, but not limited to, company, industry, role or position in company, customer satisfaction scores, product usage data, and the like, and any combination thereof. In an embodiment, customer data on web sources (such as social media) may be queried.

At S430, at least one reference is determined from the current customers based on a plurality of selection rules. In an embodiment, the plurality of selection rules defined by weights, scores, rankings, and the like are applied to the extracted customer data to determine references as a subset. As an example, two current customers of a software vendor have similar customer data in terms of role and customer satisfaction score, but differ in that customer A in the fashion industry shows greater product usage than customer B in the finance industry. In this example, by applying a plurality of selection rules including a greater weight on certain industries, here, the finance industry, for which the vendor desires to expand into, customer B may be given higher priority for selection as a reference. As another example, a reference with a recent repurchase of the vendor product and a high customer satisfaction score may be selected as a reference for the subset. In an embodiment, the subset of customers determined from current customers may be incorporated as a reference of the customer match platform to create a reference profile for smart matching as described above in FIG. 2.

At S440, a notification is generated and caused to be displayed via a vendor device (e.g., the vendor device 120, FIG. 1). In an embodiment, the notification including at least one reference is provided in the form of, for example without limitation, an email, a message via the GUI, and the like. It should be noted that notification may include basic reference information such as name, company, role in company, duration as customer, geographic location, and the like. In some embodiments, the vendor entity may select, remove, or give priority to certain references by interaction through the GUI of the vendor device (e.g., the vendor device 120, FIG. 1). In such cases, input of the vendor entity is implemented to only incorporate portions of the reference subset as references for the customer match platform. Thus, reference data for the portion of the reference subset are obtained for generating reference profiles for smart matching at the server.

In some implementations, further user data is collected through input from the selected customer via the user device associated with the customer. An invitation may be generated to be displayed at the user device for the customer to become onboard as a reference. The onboarding process may involve a step-by-step process to collect user impressions or testimonials of the vendor (e.g., product, service, company, etc.). The customer (selected to be a reference for the vendor) may provide their impressions using, for example, but not limited to, direct testimonials, answers to predetermined questionnaires, and the like, in various forms such as, but not limited to, text, audio, video, images, and the like, and any combination thereof. In an example embodiment, such input of user impressions may be utilized to create various content such as, but not limited to, a user story, quote, review, a question and answer, a video, and the like, and any combination thereof. The user story, as an example, may describe the user background, review, engagements, success rates, and the like, that provides an overview of the user in relation to the vendor. The user may be provided with the customer voice to, for example, modify, accept, give legal consent, and the like, for storage and use in the server (e.g., the server 130, FIG. 1).

In one implementation, portions of the reference data (or reference profile) may be pushed into external platforms such as, but not limited to, websites, social platforms (e.g., company social network channel or page, etc.), and the like, and any combination thereof. As an example, quotes from references may be posted on the website. As another example, reviews of different references may be posted on the company social channel (e.g., LinkedIn page) periodically. In a non-limiting example, the smart matching process may be utilized to match a reference and a visitor of the webpage as a prospect. The prospect data may be collected automatically, manually through answers to questions, or the like, and more, and a combination thereof. In the same example, a personalized website that displays smartly selected contents of references may be displayed to the visitor via, for example, a user device.

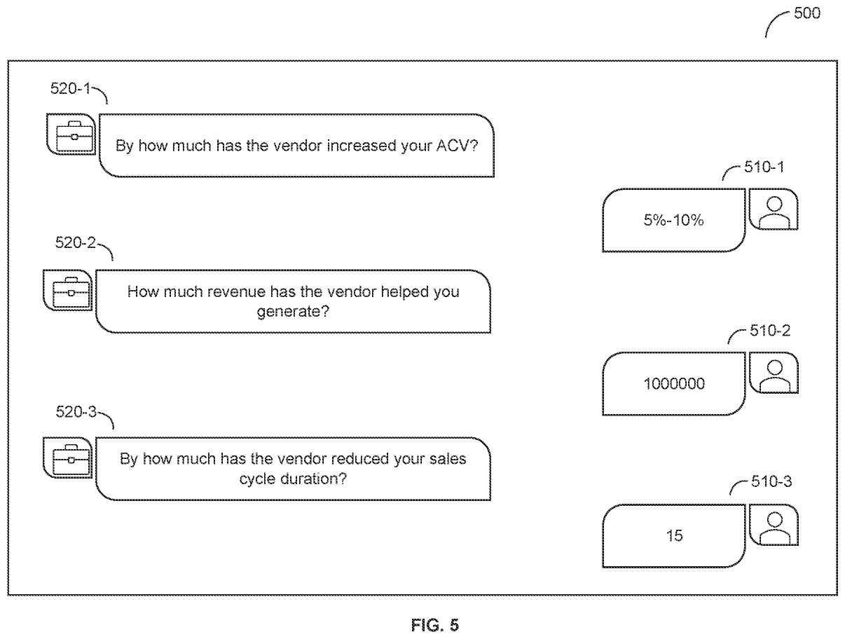

FIG. 5 is an example image 500 of a graphical user interface (GUI) showing a question-and-answer session to collect reference data according to an example embodiment. The question-and-answer session may be conducted during the onboarding process of a reference. The reference is selected from current (or existing) customers of the vendor as described in FIG. 4 herein above. During the onboarding process to collect reference data, a step-by-step process is performed to collect user impressions (or testimonials).

The example image 500 shows a question-and-answer session for the reference to input answers (510-1 through 510-3) to predetermined questionnaires (520-1 through 520-4). The predetermined questionnaires may be predetermined by a vendor and different sets may be presented to different references based on a questionnaire rule for determining the set of questionnaires to present. The questionnaire rule may be based on job title, industry type, company size, and the like, and any combination thereof. Such question-and-answer sessions may be stored within the reference profile as a content of a customer voice. As noted above, various portions of the reference profile may be utilized for smart matching with a prospect (potential customer). It should be noted that the example image 500 shows questions and answers being exchanged through text, however, the input and/or output as described herein does not limit the scope of the disclosed embodiments. The reference impressions may be collected using, for example, but not limited to, text, audio, image, video, multimedia, and the like, and any combination thereof. As an example, a user selected as a potential reference may interact with the GUI to input answers via a user device (e.g., the user device 150, FIG. 1) associated with the reference.

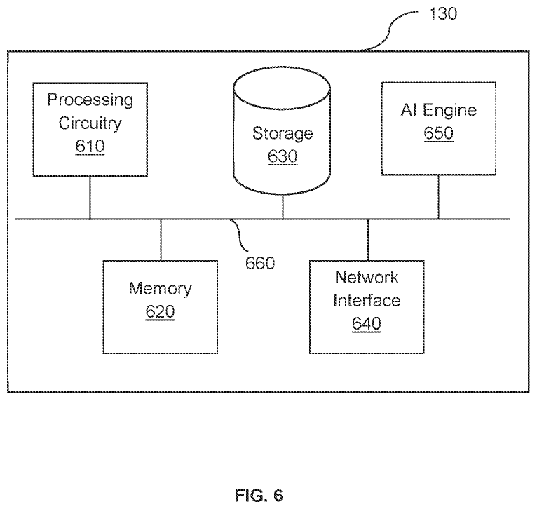

FIG. 6 is an example schematic diagram of a server 130 according to an embodiment. The server 130 includes a processing circuitry 610 coupled to a memory 620, a storage 630, a network interface 640, and an artificial intelligence (AI) engine 650. In an embodiment, the components of the server 130 may be communicatively connected via a bus 660.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read-only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the server 130 to communicate with, for example, the network 110.

The AI engine 650 may be realized as one or more hardware logic components and circuits, including graphics processing units (GPUs), tensor processing units (TPUs), neural processing units, vision processing units (VPU), reconfigurable field-programmable gate arrays (FPGA), and the like. The AI engine 650 is configured to perform, for example, machine learning based on input data such as patient data, selection data at pathway module, and more, received over the network 110.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claim is:

1. A method for facilitating an engagement through smart matching, comprising:
determining a score for at least one reference based on a plurality of matching rules applied to at least one reference profile of the at least one reference and a prospect profile for a prospect, wherein the plurality of matching rules is modified by feedback data from an engagement between the at least one reference and the prospect;
identifying, based on the determined score, a matching reference from the at least one reference for the prospect; and
tracking the engagement between the matching reference and the prospect, wherein the engagement includes a plurality of stages, wherein tracking further comprises collecting the feedback data from each stage of the plurality of stages in the engagement.

2. The method of claim 1, further comprising:
generating a notification that includes the matching reference and an invitation for the engagement; and
causing display of the notification via a user device.

3. The method of claim 2, wherein the notification includes at least one of: the prospect, the matching reference, a proposed engagement method, and a proposed engagement schedule.

4. The method of claim 1, further comprising:
generating the at least one reference profile for the at least one reference based on reference data received from at least one of: a customer relationship management (CRM) system, a vendor device, a user device, and web sources; and
creating the prospect profile for a potential customer.

5. The method of claim 1, wherein the feedback data includes engagement data and associated metadata for each stage of the plurality of stages in the engagement.

6. The method of claim 5, wherein the metadata indicates performance of the engagement data that are collected at the each stage of the plurality of stages in the engagement.

7. The method of claim 5, further comprising:
extracting content data from the engagement data; and
updating a reference profile of the matching reference based on the extracted content data and the associated metadata.

8. The method of claim 1, wherein a matching rule of the plurality of matching rules includes a disqualifying feature for eliminating portions of the at least one reference profile prior to determining the score.

9. The method of claim 1, wherein the at least one reference is selected from existing customers in a CRM system based on one or more selection rules.

10. The method of claim 1, further comprising:
aggregating the feedback data from a plurality of engagements, wherein the plurality of engagements are between a plurality of the at least one reference and a plurality of the prospects, wherein the plurality of engagements are associated with a vendor;
extracting content data from the aggregated feedback data for the vendor;
identifying at least one topic based on insight scores determined from the extracted content data; and
generating a report including the identified at least one topic for display at a vendor device of the vendor.

11. The method of claim 10, wherein the content data to extract is predetermined by the vendor.

12. A non-transitory computer readable medium having stored thereon instructions for causing a processing circuitry to execute a process, the process comprising:
determining a score for at least one reference based on a plurality of matching rules applied to at least one reference profile of the at least one reference and a prospect profile for a prospect, wherein the plurality of matching rules is modified by feedback data from an engagement between the at least one reference and the prospect;
identifying, based on the determined score, a matching reference from the at least one reference for the prospect; and
tracking the engagement between the matching reference and the prospect, wherein the engagement includes a plurality of stages, wherein tracking further comprises collecting the feedback data from each stage of the plurality of stages in the engagement.

13. A system for facilitating an engagement through smart matching, comprising:
a processing circuitry; and
a memory, the memory containing instructions that, when executed by the processing circuitry, configure the system to:
determine a score for at least one reference based on a plurality of matching rules applied to at least one reference profile of the at least one reference and a prospect profile for a prospect, wherein the plurality of matching rules is modified by feedback data from an engagement between the at least one reference and the prospect;
identify, based on the determined score, a matching reference from the at least one reference for the prospect; and
track the engagement between the matching reference and the prospect, wherein the engagement includes a plurality of stages, wherein tracking further comprises collecting the feedback data from each stage of the plurality of stages in the engagement.

14. The system of claim 13, wherein the system is further configured to:
generate a notification that includes the matching reference and an invitation for the engagement; and
cause display of the notification via a user device.

15. The system of claim 14, wherein the notification includes at least one of: the prospect, the matching reference, a proposed engagement method, and a proposed engagement schedule.

16. The system of claim 13, wherein the system is further configured to:
generate the at least one reference profile for the at least one reference based on reference data received from at least one of: a customer relationship management (CRM) system, a vendor device, a user device, and web sources; and
create the prospect profile for a potential customer.

17. The system of claim 13, wherein the feedback data includes engagement data and associated metadata for each stage of the plurality of stages in the engagement.

18. The system of claim 17, wherein the metadata indicates performance of the engagement data that are collected at the each stage of the plurality of stages in the engagement.

19. The system of claim 17, wherein the system is further configured to:
extract content data from the engagement data; and
update a reference profile of the matching reference based on the extracted content data and the associated metadata.

20. The system of claim 13, wherein a matching rule of the plurality of matching rules includes a disqualifying feature for eliminating portions of the at least one reference profile prior to determining the score.
